(19) United States
(12) Patent Application Publication
(10) Pub. No.: US 2024/0306010 A1
(43) Pub. Date: Sep. 12, 2024

(54) METHOD FOR OBTAINING DATA, TERMINAL DEVICE, AND NON-TRANSITORY COMPUTER-READABLE STORAGE MEDIUM

(71) Applicant: SPREADTRUM COMMUNICATIONS (SHANGHAI) CO., LTD., Shanghai (CN)

(72) Inventors: Xiaoyu CHEN, Shanghai (CN); Lifeng HAN, Shanghai (CN)

(21) Appl. No.: 18/264,494

(22) PCT Filed: Jan. 29, 2022
(86) PCT No.: PCT/CN2022/074979

§ 371 Date: Aug. 7, 2023

(30) Foreign Application Priority Data
Feb. 7, 2021 (CN) 202110169420.2

(51) Int. Cl. H04W 24/02; H04W 8/22; H04W 76/20

(52) U.S. Cl. CPC H04W 24/02; H04W 8/22; H04W 76/20

(57) ABSTRACT

A method for obtaining data is provided. The method for obtaining data includes the following. A terminal device receives first configuration information from a network device, where the first configuration information indicates a data collection manner for a first model, a data preprocessing manner for the first model, and/or a data reporting manner for the first model, and the first model is an artificial intelligence (AI) model used by the network device. The terminal device performs corresponding configuration based on the first configuration information.

### CROSS-REFERENCE TO RELATED APPLICATION(S)

This application is a National Stage of International Application No. PCT/CN2022/074979, filed on Jan. 29, 2022, which claims priority to Chinese Patent Application No. 202110169420.2, filed on Feb. 7, 2021, both of which are incorporated herein by reference in their entireties.

### TECHNICAL FIELD

The present disclosure relates to the field of communication technologies, and in particular, to a method for obtaining data, a terminal device, and a non-transitory computer-readable storage medium.

### BACKGROUND

Development of the artificial intelligence (AI) technology promotes automation and intelligentization of communication networks. In the related art, a network device performs training and inference on an AI model based on data reported by a terminal device. However, the data reported by the terminal device is collected and processed based on static configuration information. The static configuration information is configured in a predefined manner and will not change. Therefore, the data collection and processing manner cannot well adapt to a change in a communication environment or resource, which may degrade communication performance.

### SUMMARY

Embodiments of the present disclosure provide a method for obtaining data, a terminal device, and a non-transitory computer-readable storage medium.

According to a first aspect, an embodiment of the present disclosure provides a method for data obtaining. The method includes the following. A terminal device receives first configuration information from a network device, where the first configuration information indicates a data collection manner for a first model, a data preprocessing manner for the first model, and/or a data reporting manner for the first model, and the first model is an artificial intelligence (AI) model used by the network device. The terminal device performs corresponding configuration based on the first configuration information.

According to a second aspect, an embodiment of the present disclosure provides a terminal device. The terminal device includes a transceiver, a processor coupled to the transceiver, and a memory configured to store a computer program. The processor is configured to execute the computer program to cause the terminal device to perform the following. The terminal device receives first configuration information from a network device, where the first configuration information indicates a data collection manner for a first model, a data preprocessing manner for the first model, and/or a data reporting manner for the first model, and the first model is an AI model used by the network device. The terminal device performs corresponding configuration based on the first configuration information.

According to a third aspect, the present disclosure provides a non-transitory computer-readable storage medium. The storage medium is configured to store a computer program which, when executed by a terminal device, causes the terminal device to perform the following. The terminal device receives first configuration information from a network device, where the first configuration information indicates a data collection manner for a first model, a data preprocessing manner for the first model, and/or a data reporting manner for the first model, and the first model is an AI model used by the network device. The terminal device performs corresponding configuration based on the first configuration information.

### BRIEF DESCRIPTION OF THE DRAWINGS

In order to more clearly illustrate the technical solutions in embodiments of the present disclosure, drawings required for describing the embodiments are briefly described below.

Apparently, the drawings in the following description show some of the embodiments of the present disclosure, and a person of ordinary skill in the art may derive other drawings from these drawings without creative efforts.

FIG. 1 is a schematic diagram of a system structure of a communication system according to an embodiment of the present disclosure.

FIG. 2 is a schematic flow chart of a method for obtaining data according to an embodiment of the present disclosure.

FIG. 3 is another schematic flow chart of a method for obtaining data according to an embodiment of the present disclosure.

FIG. 4 is yet another schematic flow chart of a method for obtaining data according to an embodiment of the present disclosure.

FIG. 5 is a schematic flow chart of an activation manner according to an embodiment of the present disclosure.

FIG. 6 is a schematic flow chart of another activation manner according to an embodiment of the present disclosure.

FIG. 7 is a schematic structural diagram of a communication apparatus according to an embodiment of the present disclosure.

FIG. 8 is another schematic structural diagram of a communication apparatus according to an embodiment of the present disclosure.

FIG. 9 is yet another schematic structural diagram of a communication apparatus according to an embodiment of the present disclosure.

FIG. 10 is a schematic structural diagram of a modular device according to an embodiment of the present disclosure.

FIG. 11 is another schematic structural diagram of a modular device according to an embodiment of the present disclosure.

### DETAILED DESCRIPTION

The technical solutions in the embodiments of the present disclosure are clearly and completely described below with reference to the drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

It is to be noted that the term “and/or” herein describes only an association relationship of associated objects and represents that three relationships may exist. For example, A and/or B may represent: only A exists, both A and B exist, and only B exists. In addition, the character “/” herein generally indicates an “or” relationship between the associated objects.

The term “multiple”, “more”, or “a plurality of” in the embodiments of the present disclosure means two or more.

Descriptions such as first and second in the embodiments of the present disclosure are merely for illustrative purposes and to distinguish between the described objects, and do not mean an order, nor do they represent a special limitation on the number of devices in the embodiments of the present disclosure, and cannot constitute any limitation on the embodiments of the present disclosure.

The term “connection” in the embodiments of the present disclosure mean various connection manners such as direct or indirect connection to achieve communication between devices, which is not limited in the embodiments of the present disclosure.

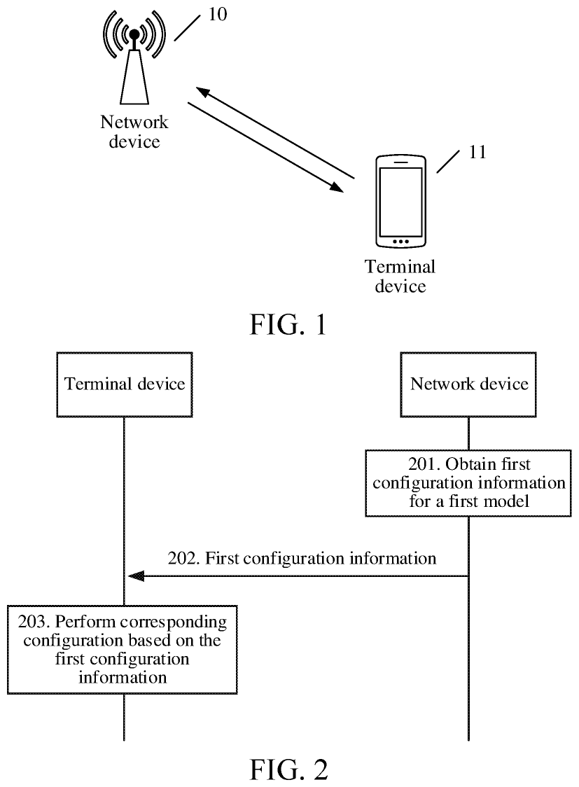

Referring to FIG. 1, FIG. 1 is a schematic diagram of a system structure of a communication system according to an embodiment of the present disclosure. The communication system may include, but is not limited to, a network device and a terminal device. The number and forms of devices shown in FIG. 1 are merely examples and do not constitute a limitation on the embodiments of the present disclosure. During actual application, the communication system may include more than one network device and more than one terminal device. The communication system shown in FIG. 1 is illustrated by using a network device 10 and a terminal device 11 as an example. The terminal device 11 may receive first configuration information from the network device 10.

In the embodiments of the present disclosure, the terminal device may also be referred to as a user equipment (UE), an access terminal, a subscriber unit, a subscriber station, a mobile station, a mobile console, a remote station, a remote terminal, a mobile device, a user terminal, a user agent, a user apparatus, or the like. The terminal device in the embodiments of the present disclosure may be a mobile phone, a tablet computer (Pad), a computer having wireless transmitting and receiving functions, a virtual reality (VR) terminal device, an augmented reality (AR) terminal device, a wireless terminal in industrial control, a wireless terminal in self driving, a wireless terminal in remote medical, a wireless terminal in a smart grid, a wireless terminal in transportation safety, a wireless terminal in a smart city, a wireless terminal in a smart home, or the like.

In the present disclosure, the network device 10 is an access device though which the terminal device 11 wirelessly connects to a mobile communication system, which may be a base station (NodeB), an evolved NodeB (eNodeB), a transmission reception point (TRP), a next generation NodeB (gNB) in a 5G mobile communication system, a base station in a future mobile communication system, or an access node in a Wi-Fi system, or may be a module or unit that completes some functions of the base station, for example, may be a centralized unit (CU) or a distributed unit (DU). A specific technology used for and a specific device form of a radio access device are not limited in this embodiment of the present disclosure. In the present disclosure, the network device may also be referred to as a radio access device. Unless otherwise specified, a radio access device means a network device.

As the artificial intelligence (AI) technology develops, application of the AI technology in a communication system can enhance performance of a communication network and promote automation and intelligentization of the communication network. For example, the network device may perform training and prediction on an AI model by using data reported by the terminal device. Currently, the data reported by the terminal device is collected and processed based on static configuration information. The static configuration information is configured in a predefined manner and will not change. When a communication environment or resource changes, if the terminal device still collects and processes data based on the static configuration information, the reported data may not meet network requirements. Therefore, the data collection and processing manner cannot well adapt to a change in the communication environment or resource, which may degrade communication performance to some extent.

The present disclosure provides a method for obtaining data. In the method for obtaining data, the terminal device receives first configuration information from the network device. The first configuration information indicates a data collection manner for a first model, a data preprocessing manner for the first model, and/or a data reporting manner for the first model, and the first model is an AI model used by the network device. The terminal device performs corresponding configuration based on the first configuration information. It may be learned that, the terminal device may receive the first configuration information from the network device, update configuration information of the terminal device based on the first configuration information, and then report collected and preprocessed data to the network device in the data collection manner, the data preprocessing manner, and/or the data reporting manner in the updated configuration information. By means of that the network device dynamically configures the configuration information of the terminal device, the terminal device can well adapt to a change in a communication environment or resource, thereby enhancing performance of a communication network.

A method for obtaining data provided in an embodiment of the present disclosure is described based on the foregoing communication system and the foregoing device. Referring to FIG. 2, FIG. 2 is a schematic flow chart of a method for obtaining data according to an embodiment of the present disclosure. The method for obtaining data includes an operation in 201 to an operation in 203.

In 201, a network device obtains first configuration information for a first model.

In the embodiment of the present disclosure, the network device may train and use multiple AI models. It is to be noted that the present disclosure is described by using an example that an AI model used by the network device is the first model. The first model may be any AI model in the multiple AI models that may be used by the network device. The first configuration information is obtained by the network device based on the first model. The first configuration information indicates a data collection manner used by the terminal device for the first model, a data preprocessing manner used by the terminal device for the first model, and/or a data reporting manner used by the terminal device for the first model. It is to be noted that the present disclosure is described by using the first model as an example.

The first configuration information may contain one or more of four indication information. The first indication information indicates the first model. For example, the first indication information may contain an AI model identifier (AI model index), an AI model configuration identifier, and/or a function identifier (use case id).

The second indication information indicates the data collection manner. For example, the second indication information may contain a data collection frequency of the terminal device, and/or contain a data collection interval.

The third indication information indicates the data preprocessing manner. For example, the third indication information may contain steps for preprocessing the collected data and specific operations in each step, such as data cleansing.

The fourth indication information indicates the data reporting manner. For example, the fourth indication information may contain a data reporting cycle and/or the number of times of data reporting.

It is to be noted that in the case where the first indication information indicates the first model, all the second indication information, the third indication information, and the fourth indication information are for the first model. That is to say, the second indication information indicates the data collection manner for the first model, the third indication information indicates the data preprocessing manner for the first model, and the fourth indication information indicates the data reporting manner for the first model.

The first configuration information may be obtained from preset configuration information based on indexes such as precision requirements of the first model, a processing capability of the terminal device, and air-interface resource limitation, or may be obtained from preset configuration information based on one index, or may be calculated based on one or more of the above indexes and a preset algorithm, or may be received from another device. The manner of obtaining the first configuration information is not limited in the present disclosure.

In a possible implementation, the network device obtains the indication information in the first configuration information and then sends the first configuration information to the terminal device in a preset format. The preset format may be:

{
data-related{

| | |
|---|---|
| use case id (or AI model index, model configuration id) | optional, |
| data reporting dimension | optional, |
| data preprocessing operation | optional, |

}
sampling-related{

| | |
|---|---|
| sampling frequency/interval | optional, |

}
reporting-related{

| | |
|---|---|
| data reporting cycle | optional, |
| number of times of data reporting | optional, |

}

| | |
|---|---|
| configuration effective time (timer or absolute time) | optional, |

}

The first indication information may contain use case id. use case id is a use case identifier. The field use case id indicates an AI function use case that uses the first configuration information and an AI model identifier used by the AI function use case. For example, in the case where use case id is 3, it indicates that use case id for the first model is 3, and the second indication information in the first configuration information indicates a data collection manner corresponding to use case id of 3, the third indication information in the first configuration information indicates a data preprocessing manner corresponding to use case id of 3, and the fourth indication information in the first configuration information indicates a data reporting manner corresponding to use case id of 3. In the case where the first indication information is default, it may indicate that all the second indication information, the third indication information, and the fourth indication information in the first configuration information may be applied to all AI function use cases.

In a possible implementation, the first indication information may be represented in two manners. A first representation manner is a model identifier. For example, there are three positioning-related models: model 1, model 2, and model 3. When use case id in the first indication information received is 3, the first indication information may indicate that the first model used by the network device is positioning-related model 3. A second representation manner is a combination of a function identifier and a model identifier. For example, in the case where use case id of positioning is 01, use case id of channel estimation is 02, use case id of channel encoding is 03, positioning-related model ids include 01, 02, and 03, channel estimation-related model ids include 01, 02, and 03, and channel encoding-related model ids include 01, 02, and 03, the first indication information may be 0101, and the first indication information may indicate that the first model used by the network device is positioning-related model 01.

In a possible implementation, the first indication information in the first configuration information may indicate a second model, and the second model is a model used by the terminal device. It may be understood that the terminal device may use the AI model to realize a network function and/or perform data collection and data preprocessing. In this case, the first indication information may be used to instruct the terminal device to adjust, based on the second model, the AI model used by the terminal device.

The second indication information may contain a sampling frequency/interval. The sampling frequency/interval may indicate a sampling frequency and a sampling duration of collection of data of the first model by the terminal device. For example, for the first model, the terminal device performs collection every 10 seconds (s) and for is each time.

The third indication information may indicate a step of data preprocessing, where the step of data preprocessing represents a step of performing preprocessing on data of the first model by the terminal device. For example, the step of preprocessing operation may include data cleansing, feature extraction, data compression, and the like.

The fourth indication information may contain a data reporting dimension, a data reporting cycle, and the number of times of data reporting. The field “data reporting dimension” indicates types and the number of indexes that need to be collected/measured and uploaded by the terminal device for the first model. For example, the first model is a model with a positioning function. In this case, the second indication information may indicate that information to be reported by the terminal device is types and the number of measurement information, such as a reference signal received power and reference signal received quality. The data reporting cycle indicates a cycle every which the terminal device needs to report data. For example, for the first model, the terminal device may report data once every 5 s. For another example, for the first model, the terminal device may perform non-cyclic data reporting. The number of times of data reporting indicates times the terminal device needs to report data. For example, for the first model, the terminal device needs to report data 100 times, and stops reporting after 100 times of data reporting. It may be understood that when the number of times of data reporting is reached, the number of times of data reporting can be restored to a default setting, or to the number of times of data reporting configured in previous configuration information, or when the number of times of data reporting is reached, negotiate with the network device to request the network device to send configuration information, which is not limited herein in the present disclosure.

In a possible implementation, the first configuration information further contains a configuration effective time. The configuration effective time may be a relative time, that is, in a timing duration of a timer, the first configuration information is valid. The configuration effective time may alternatively be an absolute time, that is, before a certain time, the first configuration information is valid. It may be understood that upon elapse of the effective period, the data collection manner, the preprocessing manner, and the reporting manner of the terminal device may be respectively restored to a default setting, or may be respectively restored to a data collection manner, a data preprocessing manner, and a data reporting manner in previous configuration information, or the terminal device may negotiate with the network device to request the network device to send configuration information, which is not limited herein in the present disclosure.

A field indicated as “Optional” may indicate that the field may be default. If the field is default, it indicates that for the field default indication information in static configuration information is used. For example, if the sampling-related {sampling frequency/interval} field in the first configuration information is default, the terminal device may extract a sampling frequency/interval corresponding to use case id from local static configuration information.

In 202, the terminal device receives the first configuration information from the network device.

In a possible implementation, when the terminal device is in a connected state (RRC connected), the network device may send the first configuration information to the terminal device through a radio resource control (RRC) message. The terminal device may update the configuration information by using the RRC message received from the network device. The RRC message contains the first configuration information.

In a possible implementation, the terminal device in the connected state (RRC connected) receives an RRC release message from the network device. The RRC release message contains the first configuration information. Furthermore, upon reception of the RRC release message, the terminal device releases a link to switch to a non-connected state, that is, an idle state (RRC idle)/inactive state (RRC inactive). In this way, it can be ensured that the terminal device in the idle state (RRC idle)/inactive state (RRC inactive) performs AI model training and prediction in an orderly manner, thereby improving precision of AI functions.

It may be understood that content of the first configuration information obtained by the network device for the terminal device in the connected state may be the same as or different from content of the first configuration information obtained by the network device for the terminal device about to enter the idle/inactive state.

In 203, the terminal device performs corresponding configuration based on the first configuration information.

In a possible implementation, when the terminal device receives the first configuration information in the connected state, the terminal device may return a receipt message to the network device. The receipt message indicates that the terminal device confirms receipt of the first configuration information.

In a possible implementation, the terminal device correspondingly updates the data collection manner for the first model, the data preprocessing manner for the first model, and/or the data reporting manner for the first model based on the received first configuration information. The data collection manner for the first model, the data preprocessing manner for the first model, and/or the data reporting manner for the first model currently stored in the terminal device may be respectively the data collection manner for the first model in the static configuration information, the data preprocessing manner for the first model in the static configuration information, and/or the data reporting manner for the first model in the static configuration information; or may be respectively a data collection manner for the first model updated based on first configuration information previously sent by the network device, a data preprocessing manner for the first model updated based on the first configuration information previously sent by the network device, and/or a data reporting manner for the first model updated based on the first configuration information previously sent by the network device.

For example, the data collection manner for the first model in the static configuration information is updated with the data collection manner in the first configuration information, the data preprocessing manner for the first model in the static configuration information is updated with the data preprocessing manner in the first configuration information, and the data reporting manner for the first model in the static configuration information is updated with the data reporting manner in the first configuration information. If a field in the first configuration information is default, a default value of the default field in the static configuration information is retained.

Further, the terminal device reports data to the network device based on the first configuration information. For example, for the first model, based on updated configuration information for the first model, the terminal device collects and preprocesses data, and reports preprocessed data to the network device.

Specifically, the terminal device may determine the first model based on the first indication information in the first configuration information, and then collect data of the first model based on the data collection manner indicated in the second indication information in the first configuration information, preprocess the collected data based on the data preprocessing manner indicated in the third indication information in the first configuration information, and report preprocessed data to the network device based on the data reporting manner indicated in the fourth indication information in the first configuration information.

For example, in order to train model 3 by the network device, the terminal device needs to perform data reporting 500 times, where data reported by the terminal device are used as training data. In this case, the first configuration information sent by the network device may be

{
data-related{
3,
signal strength information,
data cleansing, feature extraction,
}
sampling-related{
perform collection every 10s,
perform collection for 1s each time,
}
reporting-related{
perform reporting every 5s,
perform reporting 500 times,
}
configuration effective time (timer, overdue discard configuration)
}

In this case, data that needs to be reported by the terminal device in the timing duration of the timer may include signal strength information of model 3, a data preprocessing manner including data cleansing and feature extraction, a data collection manner that is performing collection every 10 s and for 1 s each time, and a data reporting manner that is performing reporting 500 times. In this way, the network device may complete the training of model 3 based on the received data reported by the terminal device.

In a possible implementation, the first indication information in the first configuration information may indicate the second model, and the second model is used by the terminal device.

For example, the terminal device may determine the second model as a model corresponding to use case id.

Optionally, the terminal device in the inactive state may initiate small data transmission (SDT) to report the preprocessed data to the network device.

In the embodiment of the present disclosure, the terminal device may receive the first configuration information from the network device, update configuration information of the terminal device based on the first configuration information, and then report collected and preprocessed data to the network device in the data collection manner, the preprocessing manner, and/or the reporting manner in the updated configuration information. By means of that the network device dynamically configures the configuration information of the terminal device, the terminal device can well adapt to a change in a communication environment or resource, thereby enhancing performance of a communication network.

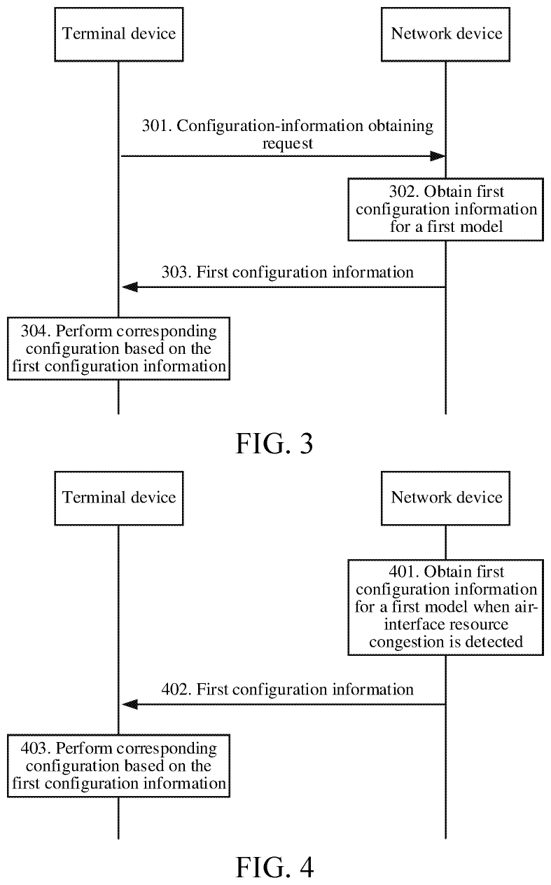

Referring to FIG. 3, FIG. 3 is another schematic flow chart of a method for obtaining data according to an embodiment of the present disclosure. The method for obtaining data includes an operation in 301 to an operation in 304.

In 301, a terminal device sends a configuration-information obtaining request to a network device.

In a possible implementation, the terminal device may send the configuration-information request to the network device. The configuration-information updating request is used for requesting the first configuration information. The first configuration information indicates a data collection manner for a first model, a data preprocessing manner for the first model, and/or a data reporting manner for the first model, and the first model is an AI model used by the network device.

The configuration-information obtaining request may contain device capability information of the terminal device, data precision requirement information, or other information, which is not limited in the present disclosure.

Specifically, the device capability information of the terminal device may indicate a current processing capability of the terminal device. The device capability information may include storage space information, calculation capability information of a central processing unit (CPU), thermal auxiliary information of the terminal device, or the like.

In a possible implementation, the terminal device may send the configuration-information obtaining request to the network device when a processing capability of the terminal device is limited. When the processing capability of the terminal device is limited, the device capability information of the terminal device may be the thermal auxiliary information. The thermal auxiliary information may indicate that a current temperature of the terminal device is higher than a preset temperature threshold, that is, overheating occurs to the terminal device. The device capability information of the terminal device may alternatively be current storage-space information. The current storage-space information may indicate that a current available storage space of the terminal device is less than a preset storage-space threshold. The device capability information of the terminal device may alternatively be the calculation capability information of the CPU. The calculation capability information of the CPU may indicate that a current calculation speed of the CPU is lower than a preset threshold. The present disclosure is not limited in this regard.

In a possible implementation, the device capability information may include a suggestion of the terminal device about changing an AI-model precision of the first model, a suggestion of the terminal device about reducing an amount of inference calculation, a suggestion of the terminal device about reducing a transmission power, and the like. In this case, the network device may obtain the first configuration information based on the device capability information and the like sent by the terminal device, and send the first configuration information to the terminal device, so that the terminal device performs corresponding configuration based on the first configuration information.

For example, the network device may adjust the data reporting manner of the terminal device for the first model based on the thermal auxiliary information, and the network device may reduce an amount of data that needs to be reported by the terminal device, thereby reducing the transmission power of the terminal device. For another example, the network device may reconfigure an AI model for the terminal device to replace the AI model currently used by the terminal device, thereby relieving overheating of the terminal device and reducing adverse impact on user experience of the terminal device.

In a possible implementation, the terminal device may send the configuration-information obtaining request to the network device when a data precision requirement is required to be changed. For example, in consideration of privacy, the terminal device needs to improve a degree of data preprocessing, to extract data unrelated to the terminal device and report the data to the network device. Thus, the terminal device may send the current device capability information. The device capability information may include information such as a data preprocessing manner suggested by the terminal device and AI-model precision requirement information. Then the network device may obtain the first configuration information based on the device capability information sent by the terminal device, and send the first configuration information to the terminal device. In this way, a risk of user privacy exposure can be reduced, security of the terminal device can be enhanced, and user experience of the terminal device can be ensured.

In a possible implementation, when the capability of the terminal device is limited, the terminal device may send the configuration-information obtaining request to the network device. Similarly, when the terminal capability is not limited, a configuration-information obtaining request containing the device capability information may be sent to the network device. In this case, the network device may obtain the first configuration information based on the device capability information sent by the terminal device, and send the obtained first configuration information to the terminal device, so that the terminal device performs corresponding configuration based on the first configuration information.

In 302, the network device obtains the first configuration information for the first model.

In 303, the terminal device receives the first configuration information from the network device.

In 304, the terminal device performs corresponding configuration based on the first configuration information.

Specific implementations of the operation in 302 to the operation in 304 are respectively the same as that of the operation in 201 to the operation in 203, and therefore is not described in detail herein.

In this embodiment of the present disclosure, the terminal device may receive the first configuration information from the network device, update configuration information of the terminal device based on the first configuration information, and then report collected and preprocessed data to the network device in the data collection manner, the preprocessing manner, and/or the reporting manner in the updated configuration information. By means of that the network device dynamically configures the configuration information of the terminal device, the terminal device can well adapt to a change in a communication environment or resource, thereby enhancing performance of a communication network.

Referring to FIG. 4, FIG. 4 is still another schematic flow chart of a method for obtaining data according to an embodiment of the present disclosure. The method for obtaining data includes an operation in 401 to an operation in 403.

In 401, a network device obtains first configuration information for a first model when air-interface resource congestion is detected by the network device.

A specific implementation of the operation in 401 is the same as that of the operation in 201, and therefore is not described in detail herein.

It is to be noted that, in a possible implementation, the network device may actively obtain the first configuration information for the first model, and send the first configuration information to a terminal device.

For example, the network device may obtain the first configuration information for the first model when air-interface resource limitation for example the air-interface resource congestion is detected by the network device. The air-interface resource congestion may be detected by a radio resource management (RRM) module of the network device. For example, when the network device detects that the number of currently available air-interface resources is less than a preset air-interface resource threshold, the network device obtains the first configuration information of the first model based on the number of the currently available air-interface resources. For example, through the first configuration information, the network device may improve a degree of preprocessing of the terminal device and adjust the data preprocessing manner of the terminal device, to increase a data compression rate, reduce an amount of data that needs to be reported by the terminal device, and reduce air interface pressure.

Further, when the network device detects that the air-interface resource congestion is relieved or solved, the network device may obtain again the first configuration information for the first model, and send the obtained first configuration information to the terminal device.

In 402, the terminal device receives the first configuration information from the network device.

In 403, the terminal device performs corresponding configuration based on the first configuration information.

Specific implementations of the operation in 402 to the operation in 403 are respectively the same as that of the operation in 202 to the operation in 203, and therefore is not described in detail herein.

In the embodiment of the present disclosure, the terminal device may receive the first configuration information from the network device, update configuration information of the terminal device based on the first configuration information, and then report collected and preprocessed data to the network device in the data collection manner, the preprocessing manner, and/or the reporting manner in the updated configuration information. By means of that the network device dynamically configures the configuration information of the terminal device, the terminal device can well adapt to a change in a communication environment or resource, thereby enhancing performance of a communication network.

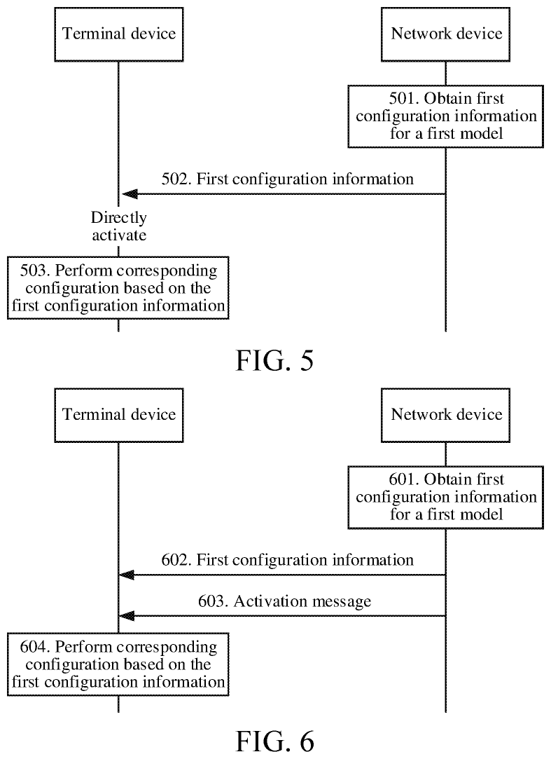

Referring to both FIG. 5 and FIG. 6, FIG. 5 and FIG. 6 are schematic flow charts each illustrating an activation manner according to an embodiment of the present disclosure.

In a possible implementation, as shown in FIG. 5, upon reception of the first configuration information, the terminal device directly activates the first configuration information. The terminal device performs corresponding configuration on the first model based on the first configuration information, and based on the updated configuration information of the first model, the terminal device collects and preprocesses data, and sends the preprocessed data to the network device. The direct activation manner is applicable to both a scenario in which the terminal device is in a connected state and a scenario in which the terminal device is in a non-connected state.

In a possible implementation, as shown in FIG. 6, in the case where the terminal device in the connected state receives the first configuration information, and the first configuration information is not currently applicable, the terminal device may store the first configuration information locally and wait for the network device to send an activation message.

The network device may send the activation message within a configuration effective time range in the first configuration information, so that the terminal device may perform corresponding configuration based on the first configuration information upon reception of the activation message, and report data to the network device based on an updated data collection manner for the first mode, an updated data preprocessing manner for the first mode, and/or an updated data reporting manner for the first model. The activation message may be a medium access control-control element (MAC CE) message, or the activation message may be part of a MAC CE message sent to the terminal device.

Compared with the direct activation manner, the activation manner using the activation message is more flexible, and with the activation manner using the activation message, faster execution and response can be realized in the case where the first configuration information has been stored in the terminal.

In a possible implementation, the network device may send a deactivation message to the terminal device. The deactivation message may be carried in a MAC CE message, and used for deactivating the first configuration information within the configuration effective time range of the first configuration information.

In a possible implementation, the operation in 602 and the operation in 603 shown in FIG. 6 may be performed simultaneously or successively, which is not limited in the present disclosure.

That is to say, the network device may send to the terminal device the first configuration information and the MAC CE message simultaneously, or may send the first configuration information to the terminal device first and then send the MAC CE message for the first model to the terminal device.

In a possible implementation, the direct activation manner may be combined with the activation manner of sending the activation message. For example, when the terminal device is in the connected state, the terminal device may receive the RRC message sent by the network device to directly activate configuration performed based on the first configuration information.

Alternatively, the terminal device may receive from the network device a MAC CE message for third configuration information used by the network device, to activate configuration performed based on the stored third configuration information. The third configuration information is configuration information of a third model used by the network device. The third configuration information may contain a data collection manner for the third model, a data preprocessing manner for the third model, and/or a data reporting manner for the third model. The specific activation manner may be determined based on requirements in actual application scenarios, and is not limited herein in the present disclosure.

In the embodiment of the present disclosure, the terminal device may receive the first configuration information from the network device, update configuration information of the terminal device based on the first configuration information, and then report collected and preprocessed data to the network device in the data collection manner, the preprocessing manner, and/or the reporting manner in the updated configuration information. By means of that the network device dynamically configures the configuration information of the terminal device, the terminal device can well adapt to a change in a communication environment or resource, thereby enhancing performance of a communication network.

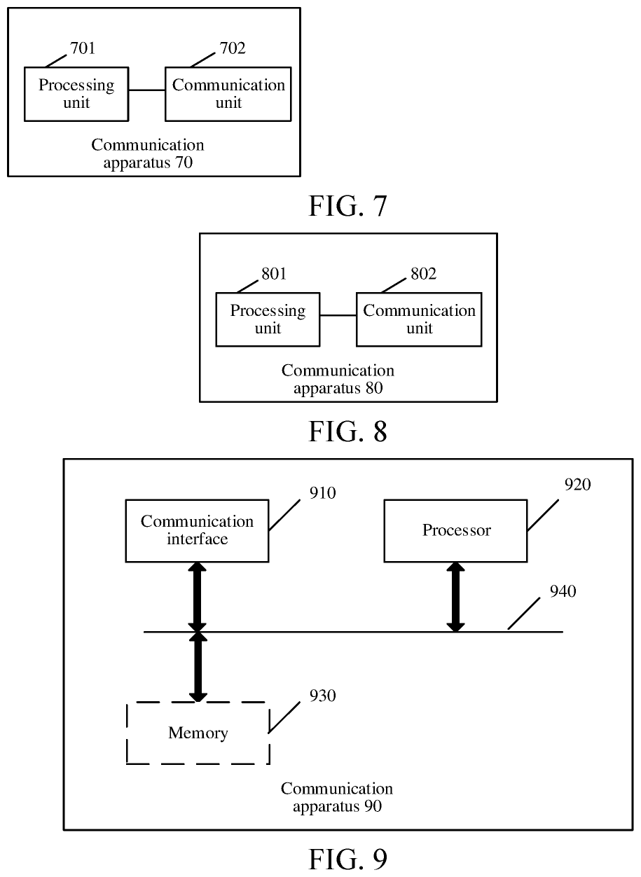

Referring to FIG. 7, FIG. 7 is a schematic structural diagram of a communication apparatus according to an embodiment of the present disclosure. The apparatus may be a terminal device, an apparatus in the terminal device, or an apparatus that may be used in cooperation with the terminal device. The communication apparatus shown in FIG. 7 may include a processing unit 701 and a communication unit 702. The processing unit 701 is configured to process data. The communication unit 702 is integrated with a receiving unit and a sending unit. The communication unit 702 may also be referred to as a transceiver unit. Alternatively, the communication unit 702 may be partitioned into a receiving unit and a sending unit.

The communication unit 702 is configured to receive first configuration information from a network device, where the first configuration information indicates a data collection manner for a first model, a data preprocessing manner for the first model, and/or a data reporting manner for the first model, and the first model is an AI model used by the network device. The processing unit 701 is configured to perform corresponding configuration based on the first configuration information.

In a possible implementation, when the first configuration information indicates the data collection manner for the first model, the data preprocessing manner for the first model, and the data reporting manner for the first model, the first configuration information contains first indication information, second indication information, third indication information, and fourth indication information, where the first indication information indicates the first model, the second indication information indicates the data collection manner, the third indication information indicates the data preprocessing manner, and the fourth indication information indicates the data reporting manner.

In a possible implementation, the communication unit 702 is further configured to send a configuration-information obtaining request to the network device, where the configuration-information obtaining request is used for requesting the first configuration information.

In a possible implementation, the configuration-information obtaining request contains device capability information of the terminal device.

In a possible implementation, the communication unit 702 configured to send the configuration-information obtaining request to the network device is specifically configured to: send the configuration-information obtaining request to the network device when a device processing capability of the terminal device is limited; or send the configuration-information obtaining request to the network device when a data precision requirement is required to be changed.

In a possible implementation, the processing unit 701 is further configured to report data to the network device based on the first configuration information.

In a possible implementation, the communication unit 702 is further configured to receive an activation message sent by the network device, where the activation message is used for activating the configuration performed based on the first configuration information.

In a possible implementation, the communication unit 702 configured to receive the first configuration information from the network device is specifically configured to receive an RRC message from the network device, where the RRC message contains the first configuration information.

In a possible implementation, the first configuration information further indicates a second model, and the processing unit 701 is further configured to adjust, based on the second model, an AI model used by the terminal device.

In this embodiment of the present disclosure, the terminal device may receive the first configuration information from the network device, update configuration information of the terminal device based on the first configuration information, and then report the collected and preprocessed data to the network device in the data manner, the preprocessing manner, and/or the reporting manner in the updated configuration information. By means of that the network device dynamically configures the configuration information of the terminal device, the terminal device can well adapt to a change in a communication environment or resource, thereby enhancing performance of a communication network.

The above communication apparatus may be, for example, a chip or a chip module. The various apparatuses and modules included in the products described in the above embodiments may be software modules or hardware modules, or may partially be software modules and partially be hardware modules. For example, all modules included in each apparatus or product applied to or integrated into a chip may be implemented by using hardware such as circuits. Alternatively, at least some modules may be implemented by using software programs run on a processor integrated in the chip, and other (if any) modules may be implemented by using hardware such as circuits. All modules included in each apparatus or product applied to or integrated into a chip module may be implemented by using hardware such as circuits. Different modules may be located in a same component (such as a chip or a circuit module) or different components of the chip module.

Alternatively, at least some modules may be implemented by using software programs run on a processor integrated in the chip module, and other (if any) modules may be implemented by using hardware such as circuits. All modules included in each apparatus or product applied to or integrated into a terminal may be implemented by using hardware such as circuits. Different modules may be located in a same component (such as a chip or a circuit module) or different components in the terminal. Alternatively, at least some modules may be implemented by using software programs run on a processor integrated in the terminal, and other (if any) modules may be implemented by using hardware such as circuits.

Referring to FIG. 8, FIG. 8 is a schematic structural diagram of another communication apparatus according to an embodiment of the present disclosure. The apparatus may be a network device, an apparatus in the network device, or an apparatus that may be used in cooperation with the network device. The communication apparatus shown in FIG. 8 may include a processing unit 801 and a communication unit 802. The processing unit 801 is configured to process data. The communication unit 802 is integrated with a receiving unit and a sending unit. The communication unit 802 may also be referred to as a transceiver unit. Alternatively, the communication unit 802 may be partitioned into a receiving unit and a sending unit.

The processing unit 801 is configured to obtain first configuration information for a first model, where the first configuration information indicates a data collection manner for the first model, a data preprocessing manner for the first model, and/or a data reporting manner for the first model, and the first model is an AI model used by the network device. The communication unit 802 is configured to send the first configuration information to a terminal device.

In this embodiment of the present disclosure, the terminal device may receive the first configuration information from the network device, update configuration information of the terminal device based on the first configuration information, and then report the collected and preprocessed data to the network device in the data manner, the preprocessing manner, and/or the reporting manner in the updated configuration information. By means of that the network device dynamically configures the configuration information of the terminal device, the terminal device can well adapt to a change in a communication environment or resource, thereby enhancing performance of a communication network.

In a possible implementation, when the first configuration information indicates the data collection manner, the data preprocessing manner, and the data reporting manner for the first model, the first configuration information contains first indication information, second indication information, third indication information, and fourth indication information, where the first indication information indicates the first model, the second indication information indicates the data collection manner, the third indication information indicates the data preprocessing manner, and the fourth indication information indicates the data reporting manner.

In a possible implementation, the communication unit 802 is further configured to receive a configuration-information obtaining request from the terminal device, where the configuration-information obtaining request is used for requesting the first configuration information.

In a possible implementation, the configuration-information obtaining request contains device capability information of the terminal device.

In a possible implementation, the processing unit 801 configured to obtain the first configuration information for the first model is specifically configured to obtain the first configuration information for the first model when air-interface resource congestion is detected by the network device.

In a possible implementation, the communication unit 802 is further configured to receive data reported by the terminal device based on the first configuration information.

In a possible implementation, the communication unit 802 is further configured to send an activation message to the terminal device, where the activation message is used for activating the configuration performed based on the first configuration information by the terminal device.

In a possible implementation, the communication unit 802 configured to send the first configuration information to the terminal device is specifically configured to send an RRC message to the terminal device, where the RRC message contains the first configuration information.

In a possible implementation, the first configuration information further indicates a second model used by the terminal device.

The above communication apparatus may be, for example, a chip or a chip module. The various apparatuses and modules included in the products described in the above embodiments may be software modules or hardware modules, or may partially be software modules and partially be hardware modules. For example, all modules included in each apparatus or product applied to or integrated into a chip may be implemented by using hardware such as circuits. Alternatively, at least some modules may be implemented by using software programs run on a processor integrated in the chip, and other (if any) modules may be implemented by using hardware such as circuits. All modules included in each apparatus or product applied to or integrated into a chip module may be implemented by using hardware such as circuits. Different modules may be located in a same component (such as a chip or a circuit module) or different components of the chip module.

Alternatively, at least some modules may be implemented by using software programs run on a processor integrated in the chip module, and other (if any) modules may be implemented by using hardware such as circuits. All modules included in each apparatus or product applied to or integrated into a terminal may be implemented by using hardware such as circuits. Different modules may be located in a same component (such as a chip or a circuit module) or different components in the terminal. Alternatively, at least some modules may be implemented by using software programs run on a processor integrated in the terminal, and other (if any) modules may be implemented by using hardware such as circuits.

Referring to FIG. 9, FIG. 9 shows still another communication apparatus 90 according to an embodiment of the present disclosure. The communication apparatus is configured to implement the functions of the terminal device in FIG. 2 and FIG. 6. The apparatus may be a terminal device or an apparatus for a terminal device. The apparatus for a terminal device may be a chip system or a chip in the terminal device. The chip system may include the chip, or may include the chip and another discrete device.

Alternatively, the communication apparatus 90 is configured to implement the functions of the network device in FIG. 2 and FIG. 6. The apparatus 90 may be a network device or an apparatus for a network device. The apparatus for a network device may be a chip system or a chip in the network device.

The communication apparatus 90 includes at least one processor 920 configured to implement the data processing function of the terminal device in the method provided in the embodiments of the present disclosure. The apparatus 90 may further include a communication interface 910 configured to implement the receiving and transmitting operations of the terminal device in the method provided in the embodiments of the present disclosure. In this embodiment of the present disclosure, the communication interface may be a transceiver, a circuit, a bus, a module, or another type of communication interface, and is configured to communicate with another device through a transmission medium. For example, the communication interface 910 is configured for an apparatus in the apparatus 90 to communicate with another device. The processor 920 receives and transmits data by using the communication interface 910, and is configured to implement the method in the above method embodiment of FIG. 2.

The apparatus 90 may further include at least one memory 930 configured to store program instructions and/or data. The memory 930 is coupled to the processor 920. The coupling in this embodiment of the present disclosure may be indirect coupling or a communicative connection between apparatuses, units, or modules in an electrical form, a mechanical form, or another form, and is used for information exchange between the apparatuses, the units, or the modules. The processor 920 may cooperate with the memory 930. The processor 920 may execute the program instructions stored in the memory 930. At least one of the at least one memory may be included in the processor.

After the apparatus 90 is powered on, the processor 920 may read a software program in the memory 930, interpret and execute instructions of the software program, and process data of the software program. When the data needs to be sent in a wireless manner, the processor 920 performs baseband processing on the to-be-sent data, and then outputs a baseband signal to a radio frequency circuit (not shown in the figure). The radio frequency circuit performs radio frequency processing on the baseband signal, and then sends the radio frequency signal in an electromagnetic wave form through an antenna. When data is sent to the apparatus 90, the radio frequency circuit receives the radio frequency signal through the antenna, converts the radio frequency signal into a baseband signal, and outputs the baseband signal to the processor 920. The processor 920 converts the baseband signal into data and processes the data.

In another implementation, the radio frequency circuit and the antenna may be arranged independently of the processor 920 performing baseband processing. For example, in a distributed scenario, the radio frequency circuit and the antenna may be independent of the communication apparatus and deployed remotely.

A specific connection medium among the communication interface 910, the processor 920, and the memory 930 is not limited in this embodiment of the present disclosure. In this embodiment of the present disclosure, in FIG. 9, the memory 930, the processor 920, and the communication interface 910 are connected through a bus 940. The bus is represented by a bold line in FIG. 9. A manner of connection between other components is merely an example for description, and the present disclosure is not limited thereto. The bus may be classified into an address bus, a data bus, a control bus, and the like. For ease of representation, only one bold line is used for representing the bus in FIG. 9, which does not mean that there is only one bus or only one type of bus.

When the apparatus 90 is specifically used for a terminal device, for example, when the apparatus 90 is specifically a chip or chip system, the communication interface 910 may output or receive a baseband signal. When the apparatus 90 is specifically a terminal device, the communication interface 910 may output or receive a radio frequency signal. In this embodiment of the present disclosure, the processor may be a general-purpose processor, a digital signal processor, an application-specific integrated circuit, a field programmable gate array or another programmable logic device, a discrete gate or transistor logic device, or a discrete hardware component. The processor can implement or execute the methods, the operations, and the logical block diagrams disclosed in the embodiments of the present disclosure. The general-purpose processor may be a microprocessor, any conventional processor, or the like. The operations of the methods disclosed in combination with the embodiments of the present disclosure may be directly implemented by a hardware processor, or may be implemented by using a combination of hardware and software modules in the processor, or the like.

It is to be noted that, the communication apparatus 90 can perform the relevant operations of the terminal device or the network device in the above method embodiments. Reference may be made to the implementation of each operation, and the details are not described herein.

All modules included in each apparatus or product applied to or integrated into a communication apparatus may be implemented by using hardware such as circuits. Different modules may be located in a same component (such as a chip or a circuit module) or different components in the terminal. Alternatively, at least some modules may be implemented by using software programs run on a processor integrated in the terminal, and other (if any) modules may be implemented by using hardware such as circuits.

An embodiment of the present disclosure further provides a chip. The chip may be configured to perform the relevant operations of the terminal device in the above method embodiments. The chip is configured to receive first configuration information from a network device, where the first configuration information indicates a data collection manner for a first model, a data preprocessing manner for the first model, and/or a data reporting manner for the first model, and the first model is an AI model used by the network device. The chip is further configured to perform corresponding configuration based on the first configuration information.

In a possible implementation, when the first configuration information indicates the data collection manner for the first model, the data preprocessing manner for the first model, and the data reporting manner for the first model, the first configuration information contains first indication information, second indication information, third indication information, and fourth indication information, where the first indication information indicates the first model, the second indication information indicates the data collection manner, the third indication information indicates the data preprocessing manner, and the fourth indication information indicates the data reporting manner.

In a possible implementation, the chip is further configured to output a configuration-information obtaining request to the network device, where the configuration-information obtaining request is used for requesting the first configuration information.

In a possible implementation, the configuration-information obtaining request contains device capability information of the terminal device.

In a possible implementation, the chip configured to send the configuration-information obtaining request to the network device is specifically configured to send the configuration-information obtaining request to the network device when a device processing capability of the terminal device is limited; or output the configuration-information obtaining request to the network device when a data precision requirement is required to be changed.

In a possible implementation, the chip is further configured to report data to the network device based on the first configuration information.

In a possible implementation, the chip is further configured to receive an activation message sent by the network device, where the activation message is used for activating the configuration performed based on the first configuration information.

In a possible implementation, the chip configured to receive the first configuration information from the network device is specifically configured to receive an RRC message from the network device, where the RRC message contains the first configuration information.

In a possible implementation, the first configuration information further indicates a second model, and the chip is further configured to adjust, based on the second model, an AI model used by the terminal device.

An embodiment of the present disclosure further provides a chip. The chip may be configured to perform the relevant operations of the network device in the above method embodiments. The chip is configured to obtain first configuration information for a first model, where the first configuration information indicates a data collection manner for the first model, a data preprocessing manner for the first model, and/or a data reporting manner for the first model, and the first model is an AI model used by the network device; and output the first configuration information to a terminal device.

In a possible implementation, when the first configuration information indicates the data collection manner for the first model, the data preprocessing manner for the first model, and the data reporting manner for the first model, the first configuration information contains first indication information, second indication information, third indication information, and fourth indication information, where the first indication information indicates the first model, the second indication information indicates the data collection manner, the third indication information indicates the data preprocessing manner, and the fourth indication information indicates the data reporting manner.

In a possible implementation, the chip is further configured to receive a configuration-information obtaining request from the terminal device, where the configuration-information obtaining request is used for requesting the first configuration information.

In a possible implementation, the configuration-information obtaining request contains device capability information of the terminal device.

In a possible implementation, the chip configured to obtain the first configuration information for the first model is specifically configured to obtain the first configuration information for the first model when air-interface resource congestion is detected by the network device.

In a possible implementation, the chip is further configured to receive data reported by the terminal device based on the first configuration information.

In a possible implementation, the chip is further configured to send an activation message to the terminal device, where the activation message is used for activating the configuration performed based on the first configuration information by the terminal device.

In a possible implementation, the chip configured to send the first configuration information to the terminal device is specifically configured to output an RRC message to the terminal device, where the RRC message contains the first configuration information.

In a possible implementation, the first configuration information further indicates a second model used by the terminal device.

In a possible implementation, the chip includes at least one processor, at least one first memory, and at least one second memory. The at least one first memory and the at least one processor are connected to each other through a circuit, and instructions are stored in the first memory. The at least one second memory and the at least one processor are connected to each other through a circuit, and the data required to be stored in the above method embodiments is stored in the second memory.

All modules included in each apparatus or product applied to or integrated into a chip may be implemented by using hardware such as circuits. Alternatively, at least some modules may be implemented by using software programs run on a processor integrated in the chip, and other (if any) modules may be implemented by using hardware such as circuits.

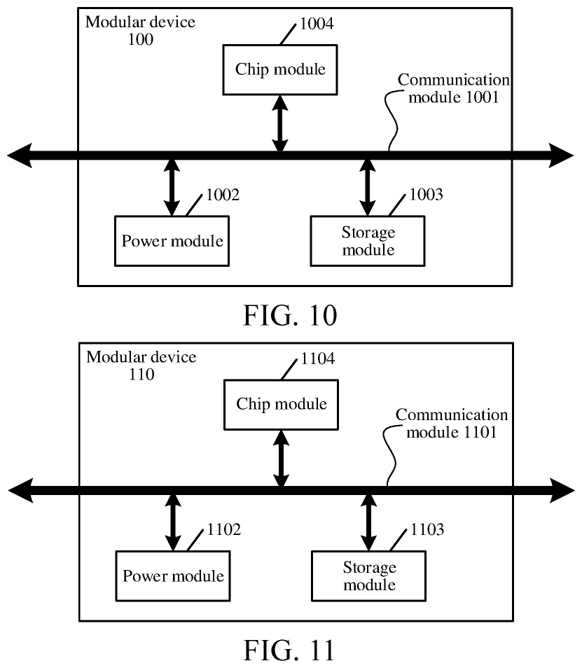

Referring to FIG. 10, FIG. 10 is a schematic structural diagram of a modular device according to an embodiment of the present disclosure. The modular device 100 can perform the relevant operations of the terminal device in the above method embodiments. The modular device 100 includes a communication module 1001, a power module 1002, a storage module 1003, and a chip module 1004.

The communication module 1001 is configured for communication in the modular device, or for communication between the modular device and an external device. The power module 1002 is configured to provide electric energy for the modular device. The storage module 1003 is configured to store data and instructions. The chip module 1004 is configured to receive first configuration information from a network device, where the first configuration information indicates a data collection manner for a first model, a data preprocessing manner for the first model, and/or a data reporting manner for the first model, and the first model is an AI model used by the network device. The chip module 1004 is further configured to perform corresponding configuration based on the first configuration information.

In a possible implementation, when the first configuration information indicates the data collection manner for the first model, the data preprocessing manner for the first model, and the data reporting manner for the first model, the first configuration information contains first indication information, second indication information, third indication information, and fourth indication information, where the first indication information indicates the first model, the second indication information indicates the data collection manner, the third indication information indicates the data preprocessing manner, and the fourth indication information indicates the data reporting manner.

In a possible implementation, the chip module 1004 is further configured to output a configuration-information obtaining request to the network device, where the configuration-information obtaining request is used for requesting the first configuration information.

In a possible implementation, the configuration-information obtaining request contains device capability information of the terminal device.

In a possible implementation, the chip module 1004 configured to send the configuration-information obtaining request to the network device is specifically configured to send the configuration-information obtaining request to the network device when a device processing capability of the terminal device is limited or output the configuration-information obtaining request to the network device when a data precision requirement is required to be changed.

In a possible implementation, the chip module 1004 is further configured to report data to the network device based on the first configuration information.

In a possible implementation, the chip module 1004 is further configured to receive an activation message sent by the network device, where the activation message is used for activating the configuration performed based on the first configuration information.

In a possible implementation, the chip module 1004 configured to receive the first configuration information from the network device is specifically configured to receive an RRC message from the network device, where the RRC message contains the first configuration information.

In a possible implementation, the first configuration information further indicates a second model, and the chip is further configured to adjust, based on the second model, an AI model used by the terminal device.

All modules included in each apparatus or product applied to or integrated into a chip module may be implemented by using hardware such as circuits. Different modules may be located in a same component (such as a chip or a circuit module) or different components of the chip module. Alternatively, at least some modules may be implemented by using software programs run on a processor integrated in the chip module, and other (if any) modules may be implemented by using hardware such as circuits.

Referring to FIG. 11, FIG. 11 is a schematic structural diagram of another modular device according to an embodiment of the present disclosure. The modular device 110 can perform the relevant operations of the access network device in the above method embodiments. The modular device 110 includes a communication module 1101, a power module 1102, a storage module 1103, and a chip module 1104.

The communication module 1101 is configured for communication in the modular device, or for communication between the modular device and an external device. The power module 1102 is configured to provide electric energy for the modular device. The storage module 1103 is configured to store data and instructions. The chip module 1104 is configured to obtain first configuration information for a first model, where the first configuration information indicates a data collection manner for the first model, a data preprocessing manner for the first model, and/or a data reporting manner for the first model, and the first model is an AI model used by the network device. and the chip module 1104 is further configured to output the first configuration information to a terminal device.

In a possible implementation, when the first configuration information indicates the data collection manner for the first model, the data preprocessing manner for the first model, and the data reporting manner for the first model, the first configuration information contains first indication information, second indication information, third indication information, and fourth indication information, where the first indication information indicates the first model, the second indication information indicates the data collection manner, the third indication information indicates the data preprocessing manner, and the fourth indication information indicates the data reporting manner.

In a possible implementation, the chip module 1104 is further configured to receive a configuration-information obtaining request from the terminal device, where the configuration-information obtaining request is used for requesting the first configuration information.

In a possible implementation, the configuration-information obtaining request contains device capability information of the terminal device.

In a possible implementation, the chip module 1104 configured to obtain the first configuration information for the first model is specifically configured to obtain the first configuration information for the first model when air-interface resource congestion is detected by the network device.

In a possible implementation, the chip module 1104 is further configured to receive data reported by the terminal device based on the first configuration information.

In a possible implementation, the chip module 1104 is further configured to send an activation message to the terminal device, where the activation message is used for activating the configuration performed based on the first configuration information by the terminal device.

In a possible implementation, the chip module 1104 configured to send the first configuration information to the terminal device is specifically configured to output an RRC message to the terminal device, where the RRC message contains the first configuration information.

In a possible implementation, the first configuration information further indicates a second model used by the terminal device.

All modules included in each apparatus or product applied to or integrated into a chip module may be implemented by using hardware such as circuits. Different modules may be located in a same component (such as a chip or a circuit module) or different components of the chip module. Alternatively, at least some modules may be implemented by using software programs run on a processor integrated in the chip module, and other (if any) modules may be implemented by using hardware such as circuits.

An embodiment of the present disclosure further provides a computer-readable storage medium storing instructions. When the instructions are run on a processor, the method process of the above method embodiments are implemented.

An embodiment of the present disclosure further provides a computer program product.

When the program product is run on a processor, the method process of the above method embodiments is implemented.

It is to be noted that, for brevity, the above method embodiments are described as a series of action combinations. However, a person skilled in the art is to be aware that the present disclosure is not limited to the order of the described actions, because some operations may be performed in another sequence or simultaneously according to the present disclosure. In addition, a person skilled in the art is further to understand that the embodiments in the description are exemplary embodiments, and the involved actions and modules mentioned are not necessarily required by the present disclosure.

For the descriptions of various embodiments provided in the present disclosure, reference may be made to each other, and the descriptions of various embodiments have respective emphasis. For parts not described in detail in an embodiment, reference may be made to related descriptions of another embodiment. For convenience and conciseness of the description, for example, for the functions and operations of the various apparatuses and devices provided in the embodiments of the present disclosure, reference may be made to the relevant descriptions of the method embodiments of the present disclosure, and reference, combination, or citing is also allowed between the method embodiments and device embodiments.

Finally, it is to be noted that: the above embodiments are merely used for describing the technical solutions of the present disclosure, but not to limit the present disclosure. Although the embodiments of the present disclosure are described in detail with reference to the foregoing embodiments, it is to be understood by a person of ordinary skill in the art that, modifications may still be made to the technical solutions recorded in the above embodiments, or equivalent replacements may be made to some or all of the technical features; and these modifications or replacements do not cause the essence of corresponding technical solutions to depart from the scope of the technical solutions in the embodiments of the present disclosure.

1. A method for obtaining data, comprising:
receiving, by a terminal device, first configuration information from a network device, wherein the first configuration information indicates a data collection manner for a first model, a data preprocessing manner for the first model, and/or a data reporting manner for the first model, and the first model is an artificial intelligence (AI) model used by the network device; and
performing, by the terminal device, corresponding configuration based on the first configuration information.

2. The method according to claim 1, wherein when the first configuration information indicates the data collection manner for the first model, the data preprocessing manner for the first model, and the data reporting manner for the first model, the first configuration information contains:
first indication information, second indication information, third indication information, and fourth indication information, wherein the first indication information indicates the first model, the second indication information indicates the data collection manner, the third indication information indicates the data preprocessing manner, and the fourth indication information indicates the data reporting manner.

3. The method according to claim 1, further comprising:
sending, by the terminal device, a configuration-information obtaining request to the network device, wherein the configuration-information obtaining request is used for requesting the first configuration information.

4. The method according to claim 3, wherein the configuration-information obtaining request contains device capability information of the terminal device.

5. The method according to claim 4, wherein sending, by the terminal device, the configuration-information obtaining request to the network device comprises:
sending, by the terminal device, the configuration-information obtaining request to the network device when a device processing capability of the terminal device is limited; or
sending, by the terminal device, the configuration-information obtaining request to the network device when a data precision requirement is required to be changed.

6. The method according to claim 1, further comprising:
reporting, by the terminal device, data to the network device based on the first configuration information.

7. The method according to claim 1, further comprising:
receiving, by the terminal device, an activation message sent by the network device, wherein the activation message is used for activating the configuration performed based on the first configuration information.

8. The method according to claim 1, wherein receiving, by the terminal device, the first configuration information from the network device comprises:
receiving, by the terminal device, a radio resource control (RRC) message from the network device, wherein the RRC message contains the first configuration information.

9. The method according to claim 1, wherein the first configuration information indicates a second model, and the method further comprises:
adjusting, by the terminal device based on the second model, an AI model used by the terminal device.

10-26. (canceled)

27. A terminal device comprising:
a transceiver;
a processor coupled to the transceiver; and
a memory configured to store a computer program;
the processor configured to execute the computer program to cause the terminal device to:
receive first configuration information from a network device, wherein the first configuration information indicates a data collection manner for a first model, a data preprocessing manner for the first model, and/or a data reporting manner for the first model, and the first model is an artificial intelligence (AI) model used by the network device; and
perform corresponding configuration based on the first configuration information.

28. The terminal device of claim 27, wherein when the first configuration information indicates the data collection manner for the first model, the data preprocessing manner for the first model, and the data reporting manner for the first model, the first configuration information contains:
first indication information, second indication information, third indication information, and fourth indication information, wherein the first indication information indicates the first model, the second indication information indicates the data collection manner, the third indication information indicates the data preprocessing manner, and the fourth indication information indicates the data reporting manner.

29. The terminal device according to claim 27, wherein the processor is further configured to execute the computer program to cause the terminal device to:
send a configuration-information obtaining request to the network device, wherein the configuration-information obtaining request is used for requesting the first configuration information.

30. The terminal device according to claim 29, wherein the configuration-information obtaining request contains device capability information of the terminal device.

31. The terminal device according to claim 30, wherein the processor configured to execute the computer program to cause the terminal device to send the configuration-information obtaining request to the network device is configured to execute the computer program to cause the terminal device to:
send the configuration-information obtaining request to the network device when a device processing capability of the terminal device is limited; or
send the configuration-information obtaining request to the network device when a data precision requirement is required to be changed.

32. The terminal device according to claim 27, wherein the processor is further configured to execute the computer program to cause the terminal device to:
report data to the network device based on the first configuration information.

33. The terminal device according to claim 27, wherein the processor is further configured to execute the computer program to cause the terminal device to:
receive an activation message sent by the network device, wherein the activation message is used for activating the configuration performed based on the first configuration information.

34. The terminal device according to claim 27, wherein the processor configured to execute the computer program to cause the terminal device to receive the first configuration information from the network device is configured to execute the computer program to cause the terminal device to:
receive a radio resource control (RRC) message from the network device, wherein the RRC message contains the first configuration information.

35. The terminal device according to claim 27, wherein the first configuration information indicates a second model, and the processor is further configured to execute the computer program to cause the terminal device to:
adjust, based on the second model, an AI model used by the terminal device.

36. A non-transitory computer-readable storage medium configured to store a computer program, the computer program, when executed by a terminal device, causing the terminal device to:
receive first configuration information from a network device, wherein the first configuration information indicates a data collection manner for a first model, a data preprocessing manner for the first model, and/or a data reporting manner for the first model, and the first model is an artificial intelligence (AI) model used by the network device; and
perform corresponding configuration based on the first configuration information.

37. The non-transitory computer-readable storage medium of claim 36, wherein when the first configuration information indicates the data collection manner for the first model, the data preprocessing manner for the first model, and the data reporting manner for the first model, the first configuration information contains:
first indication information, second indication information, third indication information, and fourth indication information, wherein the first indication information indicates the first model, the second indication information indicates the data collection manner, the third indication information indicates the data preprocessing manner, and the fourth indication information indicates the data reporting manner.
